(19) United States
(12) Patent Application Publication
(10) Pub. No.: US 2011/0133991 A1
(43) Pub. Date: Jun. 9, 2011

(54) DIELECTRIC RESONATOR ANTENNA EMBEDDED IN MULTILAYER SUBSTRATE

(76) Inventors: Jung Aun Lee, Gyunggi-do (KR); Moonil Kim, Gyunggi-do (KR); Kook Joo Lee, Seoul (KR); Chul Gyun Park, Gyunggi-do (KR)

(21) Appl. No.: 12/710,163

(22) Filed: Feb. 22, 2010

(30) Foreign Application Priority Data
Dec. 8, 2009 (KR) 10-2009-0121323

(51) Int. Cl. H01Q 9/04

(52) U.S. Cl. 343/700 MS

(57) ABSTRACT

Disclosed is a dielectric resonator antenna embedded in a multilayer substrate, which includes a multilayer substrate, a first conductor plate having an opening, a second conductor plate formed on the bottom of a lowermost insulating layer resulting from stacking at least two insulating layers downward from the first conductor plate, a plurality of metal via holes passing through around the opening at a predetermined interval, and a feeder for transmitting a frequency signal to the dielectric resonator embedded by the metal boundaries defined by the first conductor plate, the second conductor plate and the plurality of metal via holes, thus exhibiting low sensitivity to fabrication error and the external environment.

### CROSS REFERENCE TO RELATED APPLICATION

This application claims the benefit of Korean Patent Application No. 10-2009-0121323, filed Dec. 8, 2009, entitled “Dielectric resonator antenna embedded in multilayer substrate”, which is hereby incorporated by reference in its entirety into this application.

### BACKGROUND OF THE INVENTION

1. Technical Field

The present invention relates to a dielectric resonator antenna embedded in a multilayer substrate.

2. Description of the Related Art

Conventional transmission and receiving systems are mostly fabricated by assembling respective components. However, research into system-on-package products in which a transmission and receiving system of the millimeter wave band is fabricated into a single package is being conducted these days, and part of the products is commercially available.

Technology for single package products has been developed together with multilayer substrate fabrication techniques for stacking dielectric substrates such as low temperature co-fired ceramic (LTCC) and liquid crystal polymer (LCP).

Such multilayer substrate packages are fabricated through a unified process by integrating integrated circuits as an active element and embedding passive elements in the package, thereby reducing the wiring to thus decrease the inductance component, lessening the loss caused by bonding between the elements, and reducing the production cost of the products.

However, if the substrate is burned during the fabrication of the LTCC, it may shrink by about 15% in the directions of x and y which are the planar directions of the substrate, undesirably causing a fabrication error resulting in poor reliability of products.

In multilayer structures such as LTCC and LCP, a patch antenna having planar characteristics is mainly used, but is problematic because of a narrow bandwidth of about 5%.

In order to broaden the bandwidth of the patch antenna, a useful item is a patch antenna for primary radiation and including a parasitic patch additionally formed on the same plane as the patch antenna to thus generate multi-resonance, or a stacked patch antenna having two or more stacked patch antennas to thus induce multi-resonance.

Conventionally, it is known that a bandwidth of about 10% may be obtained using the above method for inducing multi-resonance.

However, in the case of using multi-resonance, there may occur a difference in radiation patterns of the antenna at respective resonant frequencies, and changes in antenna characteristics due to the fabrication error may become greater compared to the single resonance antenna.

Thus, in order to increase performance of the antenna and to ensure the broader bandwidth, a conventional dielectric resonator antenna may be adopted.

Compared to the conventional multi-resonance patch antenna, the conventional dielectric resonator antenna is known to be superior in terms of bandwidth and performance.

Although the conventional dielectric resonator antenna has been frequently used to solve drawbacks of the conventional patch antenna, it needs an additional dielectric resonator located outside the substrate and thus makes its fabrication difficult, compared to the patch antenna having a multilayer structure resulting from a single process.

### SUMMARY OF THE INVENTION

Accordingly, the present invention has been made keeping in mind the problems encountered in the related art and the present invention is intended to provide a dielectric resonator antenna embedded in a multilayer substrate, which is easily fabricated using a single multilayer substrate fabrication process and in which changes in antenna characteristics due to a fabrication error are small.

An aspect of the present invention provides a dielectric resonator antenna embedded in a multilayer substrate, including a multilayer substrate formed by alternately stacking a plurality of insulating layers and a plurality of conductor layers, a first conductor plate having an opening and formed on a top of an uppermost insulating layer of the multilayer substrate, a second conductor plate formed on a bottom of a lowermost insulating layer resulting from stacking at least two insulating layers downward from the first conductor plate and located at a position corresponding to the opening, a plurality of metal via holes formed to perpendicularly pass through the multilayer substrate so as to form interlayer electrical connections between the uppermost insulating layer and the lowermost insulating layer and so as to be arranged around the opening of the first conductor plate at a predetermined interval thus forming a metal boundary in a perpendicular direction, and a feeder for applying a high-frequency signal to a dielectric resonator embedded in cavity form in the multilayer substrate by metal boundaries defined by the first conductor plate, the second conductor plate and the plurality of metal via holes.

In this aspect, the dielectric resonator may have a hexahedron shape.

In this aspect, the dielectric resonator may have a cylinder shape.

In this aspect, the dielectric resonator may have a polygonal pillar shape.

In this aspect, the feeder may have a strip line structure, which includes a feed line composed of a conductor plate in line form extending from one side of the dielectric resonator to be inserted to an inside of the dielectric resonator so as to be parallel to the opening of the dielectric resonator, a first ground plate located to correspond to the feed line and formed on a top of an insulating layer resulting from stacking at least one insulating layer upward from the feed line, and a second ground plate located to correspond to the feed line and formed on a bottom of an insulating layer resulting from stacking at least one insulating layer downward from the feed line.

As such, the first ground plate may be integrated with the first conductor plate.

Furthermore, in the strip line structure, the feed line may be formed between a bottom of the uppermost insulating layer and a top of the lowermost insulating layer.

Furthermore, in the strip line structure, the feed line may have an end having a straight shape, a step shape, a taper shape or a round shape.

In this aspect, the feeder may have a microstrip line structure, which includes a feed line composed of a conductor plate in line form extending from one side of the dielectric resonator to be inserted to an inside of the dielectric resonator so as to be parallel to the opening of the dielectric resonator, and a ground plate located to correspond to the feed line and formed on a bottom of an insulating layer resulting from stacking at least one insulating layer from the feed line.

As such, in the microstrip line structure, the feed line may be formed on the top of the uppermost insulating layer.

Furthermore, in the microstrip line structure, the feed line may have an end having a straight shape, a step shape, a taper shape or a round shape.

In this aspect, the feeder may have a coplanar waveguide (CPW) line structure, which includes a feed line composed of a conductor plate in line form extending from one side of the dielectric resonator to be inserted to an inside of the dielectric resonator so as to be parallel to the opening of the dielectric resonator, a first ground plate formed on a surface same as the feed line and spaced apart from one side of the feed line, and a second ground plate formed on the surface same as the feed line and spaced apart from the other side of the feed line.

As such, in the CPW line structure, the first ground plate and the second ground plate may be integrated with the first conductor plate.

Furthermore, in the CPW line structure, the feed line may be formed on the top of the uppermost insulating layer.

Furthermore, in the CPW line structure, the feed line may have an end having a straight shape, a step shape, a taper shape or a round shape.

### BRIEF DESCRIPTION OF THE DRAWINGS

The features and advantages of the present invention will be more clearly understood from the following detailed description taken in conjunction with the accompanying drawings, in which:

FIGS. 1 and 2 are exploded perspective views showing examples of a dielectric resonator antenna embedded in a multilayer substrate according to a first embodiment of the present invention;

FIG. 3 is a top plan view of FIG. 1;

FIG. 4 is a cross-sectional view of FIG. 1 taken along the line A-A′ of FIG. 3;

FIG. 5 is a cross-sectional view of FIG. 2 taken along the line A-A′ of FIG. 3;

FIG. 6 is a simulation graph showing changes in antenna characteristics due to a fabrication error in a conventional stacked patch antenna;

FIG. 7 is a simulation graph showing changes in antenna characteristics due to a fabrication error in the dielectric resonator antenna embedded in the multilayer substrate according to the first embodiment of the present invention;

FIG. 8 is a graph showing a frequency shift depending on the fabrication error in the conventional stacked patch antenna and the dielectric resonator antenna according to the present invention;

FIG. 9 is a top plan view showing a dielectric resonator antenna embedded in a multilayer substrate according to a second embodiment of the present invention;

FIG. 10 is a simulation graph showing return loss depending on frequency in the dielectric resonator antenna of FIG. 9;

FIG. 11 is a cross-sectional view showing the dielectric resonator antenna of FIGS. 1 to 5 which further includes an outer dielectric;

FIG. 12 is a simulation graph showing return loss depending on frequency at different dielectric constants (∈ᵣ) of the outer dielectric which is further provided in the conventional stacked patch antenna;

FIG. 13 is a simulation graph showing return loss depending on frequency at different dielectric constants (∈ᵣ) of the outer dielectric which is further provided in the antenna according to the present invention;

FIG. 14 is an exploded perspective view showing the dielectric resonator antenna according to the present invention which includes a feeder having a strip line structure positioned differently from FIG. 1;

FIG. 15 is a top plan view of FIG. 14;

FIG. 16 is a cross-sectional view of FIG. 14 taken along the line B-B′ of FIG. 15;

FIG. 17 is an exploded perspective view showing the dielectric resonator antenna according to the present invention which includes a feeder having a microstrip line structure;

FIG. 18 is a top plan view of FIG. 17;

FIG. 19 is a cross-sectional view of FIG. 17 taken along the line C-C′ of FIG. 18;

FIG. 20 is an exploded perspective view showing the dielectric resonator antenna according to the present invention which includes a feeder having a coplanar waveguide line structure;

FIG. 21 is a top plan view of FIG. 20; and

FIG. 22 is a cross-sectional view of FIG. 20 taken along the line D-D′ of FIG. 21.

### DESCRIPTION OF SPECIFIC EMBODIMENTS

Hereinafter, embodiments of the present invention will be described in detail while referring to the accompanying drawings.

For the sake of description, a multilayer substrate 1 according to the present invention includes a substrate composed of four stacked insulating layers, but the present invention is not limited thereto.

In the drawings according to the present invention, it is noted that a conductor layer other than a conductor layer for a feeder is regarded as having been omitted.

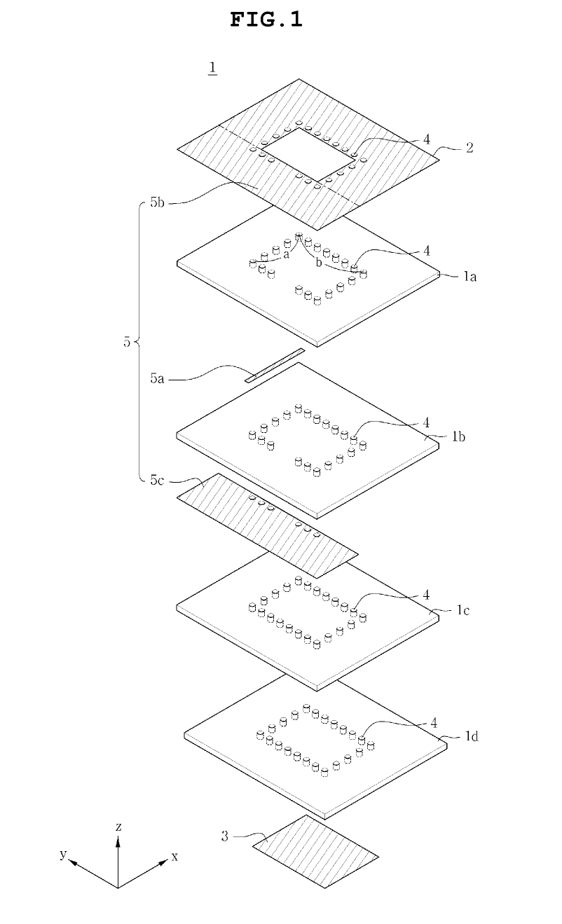

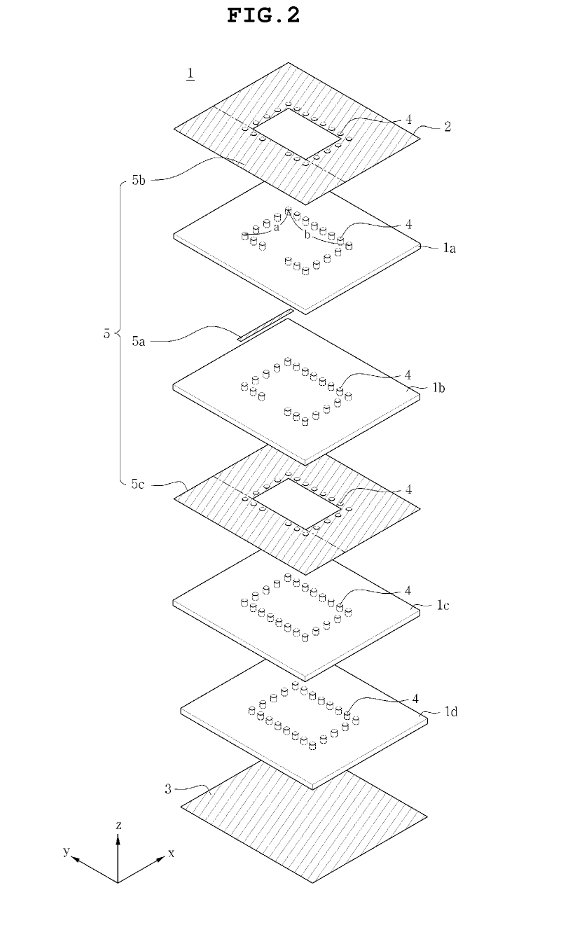

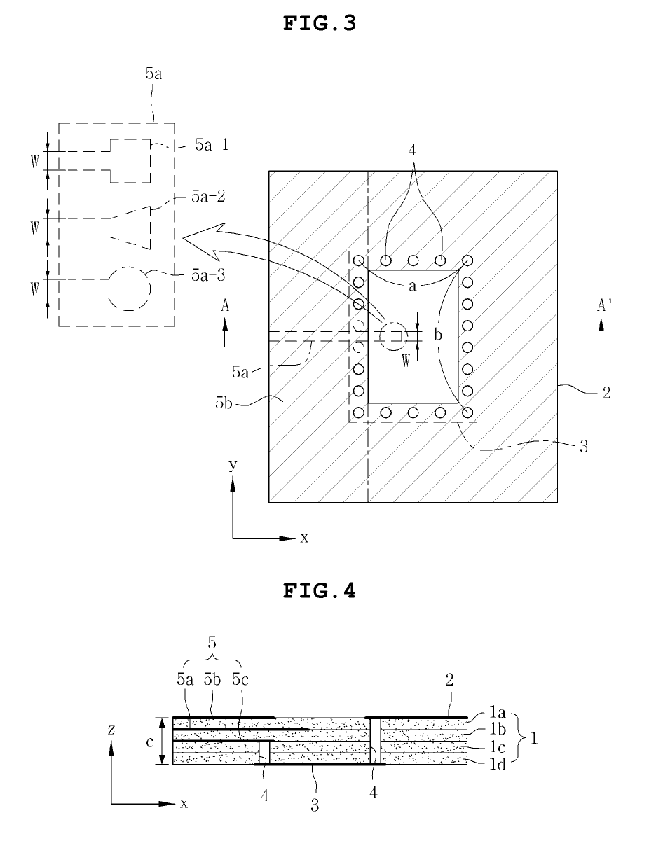

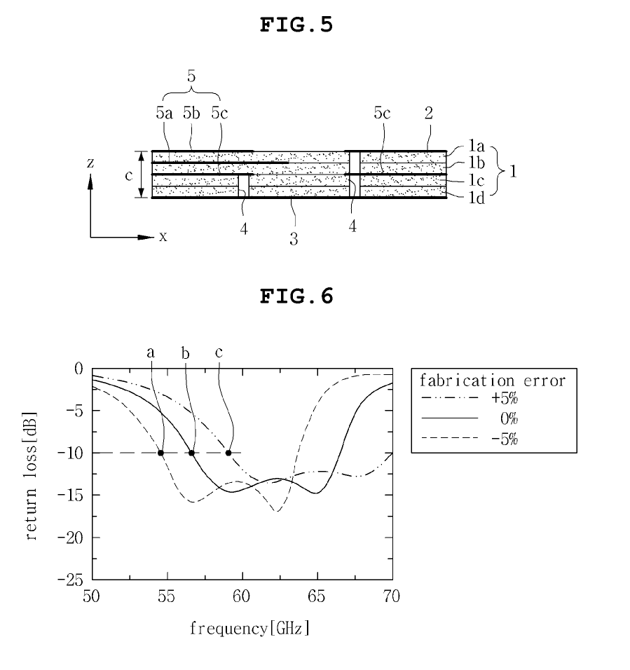

FIGS. 1 and 2 are exploded perspective views showing examples of a dielectric resonator antenna embedded in a multilayer substrate according to a first embodiment of the present invention, FIG. 3 is a top plan view of FIG. 1, and FIGS. 4 and 5 are respectively cross-sectional views of FIG. 1 and FIG. 2 taken along the line A-A′ of FIG. 3.

With reference to FIGS. 1 and 2, the dielectric resonator antenna embedded in the multilayer substrate according to the first embodiment of the present invention includes a multilayer substrate 1, a first conductor plate 2 having an opening in the center thereof and formed on the top of the uppermost insulating layer 1a of the multilayer substrate 1, a second conductor plate 3 located on the bottom of the lowermost insulating layer 1d of the multilayer substrate 1, a plurality of metal via holes 4 passing through from the uppermost insulating layer 1a to the lowermost insulating layer 1d, and a feeder 5 including a feed line 5a and at least one ground plate 5b, 5c.

The multilayer substrate 1 is formed by alternately stacking a plurality of insulating layers 1a-1d and a plurality of conductor layers (e.g. 2, 3, 5a, 5c), whereby the dielectric resonator may be embedded in the multilayer substrate 1.

In a conventional dielectric resonator antenna, there occurs a difference in dielectric constant between the air and the dielectric antenna provided in rectangular parallelepiped or cylinder form on a single substrate for a particular feeder, so that the boundary therebetween acts as a magnetic wall, thus forming a resonant mode at a specific frequency.

However, in the dielectric resonator embedded in the multilayer substrate 1 according to the present invention, the resonant mode is maintained by using the metal boundary perpendicular to the multilayer substrate 1, the metal boundary defined by the conductor plate located on the bottom of the lowermost insulating layer of the multilayer substrate 1 and the magnetic wall of the opening formed on the top of the uppermost insulating layer.

As such, in the multilayer structure, the metal boundary perpendicular to the substrate is ideally required but may be replaced with a plurality of metal vias arranged at a predetermined interval because of the difficulty of fabrication.

Therefore, as shown in FIGS. 1 and 2, in order to embed the dielectric resonator in the multilayer substrate 1, the first conductor plate 2 having the opening is formed on the top of the uppermost insulating layer 1a.

Also, the second conductor plate 3 is formed at the position, corresponding to the opening of the first conductor plate 2, on the bottom of the lowermost insulating layer 1d resulting from stacking at least two insulating layers downward from the first conductor plate 2.

As such, as shown in FIG. 1, the second conductor plate 3 is exemplified by a conductor plate having a size defined by the plurality of metal via holes 4.

However, this size is only a minimum size for embodying the dielectric resonator according to the first embodiment of the present invention. As shown in FIG. 2, a conductor plate having the same size as the multilayer substrate 1 may be used.

The plurality of metal via holes 4 is formed to perpendicularly pass through the multilayer substrate 1 so as to form interlayer electrical connections between the uppermost insulating layer 1a and the lowermost insulating layer 1d and also so as to be arranged around the opening of the first conductor plate 2 at a predetermined interval thus forming the metal boundary in a perpendicular direction.

Thereby, the dielectric resonator, only one surface (e.g. the surface of the first conductor plate 2 having the opening) of which is opened, is embedded in cavity form in the multilayer substrate 1 by the metal boundaries defined by the first conductor plate 2, the second conductor plate 3 and the plurality of metal via holes 4.

The dielectric resonator embedded in the multilayer substrate 1 is typically provided in the shape of a hexahedron or cylinder, but the present invention is not limited thereto and any shape may be applied.

For example, the dielectric resonator may also be fabricated in the shape of any type of polygonal pillar because the plurality of metal via holes 4 is formed in a perpendicular direction depending on the shape of the opening of the first conductor plate 2.

The size of the dielectric resonator to be fabricated may be adjusted depending on the desired resonant frequency.

For example, in the case of a rectangular parallelepiped shape as shown in FIGS. 1 and 2, the dielectric resonator may be fabricated by adjusting the length a in the direction of x parallel to the length of the feed line 5a, the length b in the direction of y and the length (thickness) c in the direction of z. In the case of a cylinder shape which will be described later, the dielectric resonator may be fabricated by adjusting the diameter R and the length (thickness) c in the direction of z.

The feeder 5 is formed at one side of the dielectric resonator in order to transmit high frequency signals to the dielectric resonator embedded in the multilayer substrate 1.

The feeder 5 is embodied to transmit high frequency signals using a transmission line (hereinafter, referred to as a ‘feed line’) such as a strip line, a microstrip line and a coplanar waveguide (CPW) line, which may be easily formed on the multilayer substrate 1.

The feeder 5 includes a single feed line 5a and at least one ground plate 5b, 5c.

The feeder 5 of the dielectric resonator antenna as shown in FIGS. 1 and 2 has a strip line structure.

Specifically, the feeder 5 having a strip line structure includes a feed line 5a, a first ground plate 5b and a second ground plate 5c.

The feed line 5a is composed of a conductor plate in line form extending from one side of the dielectric resonator to be inserted to the inside of the dielectric resonator so as to be parallel to the opening of the dielectric resonator.

The end of the feed line 5a inserted to the inside of the dielectric resonator antenna has a traditional straight shape, but may be provided in the form of a step shape 5a-1, a taper shape 5a-2 or a round shape 5a-3, as shown in FIG. 3.

The first ground plate 5b is located to correspond to the feed line 5a, and is formed on the top of the insulating layer 1a resulting from stacking at least one insulating layer upward from the feed line 5a.

The second ground plate 5c is located to correspond to the feed line 5a, and is formed on the bottom of the insulating layer 1b resulting from stacking at least one insulating layer downward from the feed line 5a.

The first and second ground plates 5b, 5c must be surely located at the position corresponding to the feed line 5a, and the size and shape thereof are not limited.

In FIGS. 1 and 2, the first ground plate 5b at least needs only a predetermined region 5b, at the position corresponding to the feed line 5a, among regions divided by a dotted line, but may be replaced with the first conductor plate 2 including the above region 5b.

Specifically, the first ground plate 5b may be integrated with the first conductor plate 2.

Also in FIG. 1, the second ground plate 5c is exemplified by a conductor plate including a predetermined region at the position corresponding to the feed line 5a, but may include a conductor plate having the same shape and size as the first conductor plate 2, as shown in FIG. 2.

In the case of the dielectric resonator antenna embedded in the multilayer substrate 1 according to the first embodiment of the present invention as shown in FIGS. 1 and 2, the feed line 5a is formed on the top of the second insulating layer 1b. The first ground plate 5b is formed on the top of the insulating layer 1a resulting from stacking one or more insulating layers upward from the feed line 5a, and furthermore, the second ground plate 5c is formed on the bottom of the insulating layer 1b resulting from stacking one or more insulating layers downward from the feed line 5a.

Thus, a part of the first conductor plate 2 may function as the first ground plate 5b as mentioned above.

Comparing FIG. 1 (or FIG. 4) with FIG. 2 (or FIG. 5), examples of the dielectric antenna embedded in the multilayer substrate 1 according to the first embodiment may perform the same functions, with the exception that only the sizes of the second conductor plate 3 and the first and second ground plates 5b, 5c are different.

Below, the dielectric resonator antenna of FIG. 1 is described, and the detailed description of the dielectric resonator antenna of FIG. 2 is omitted.

High frequency signals are applied to the dielectric resonator embedded in the multilayer substrate 1 as above via the feed line 5a of the feeder 5, and this resonator plays the role of an antenna radiator for radiating, through the opening, high frequency signals which resonate at a specific frequency depending on the shape and size of the dielectric resonator.

The feed line 5a of the feeder 5 may be located at any position between the top of the uppermost insulating layer 1a of the multilayer substrate 1 and the top of the lowermost insulating layer 1d thereof.

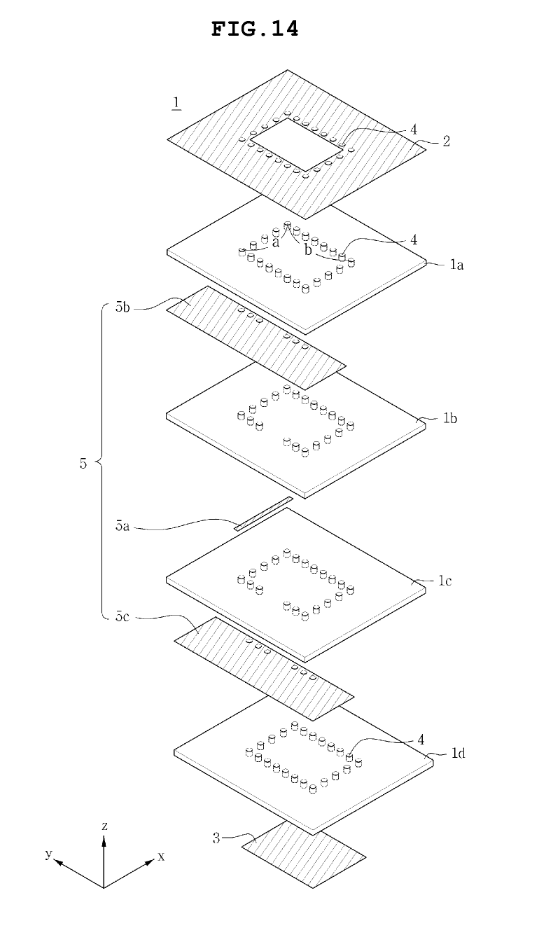

The structure of a feeder in another form and the position relationship of the feeder 5 depending on the position of the feed line 5a upon fabrication are specified below with reference to FIGS. 14 to 22.

Compared to a conventional patch antenna or stacked patch antenna, the dielectric resonator antenna embedded in the multilayer substrate according to the first embodiment is advantageous because changes in antenna characteristics due to a fabrication error are small.

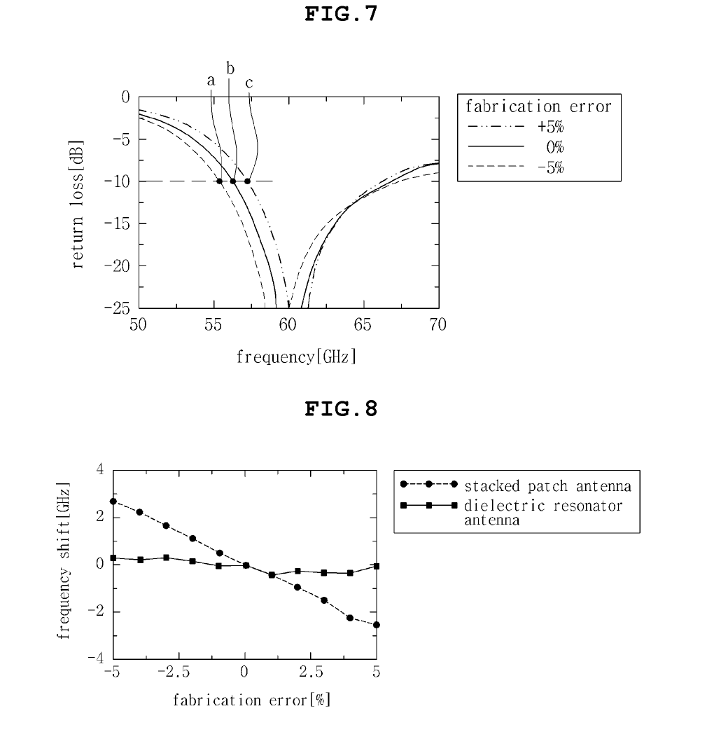

The sensitivities to fabrication error will be compared while making reference to the graphs of FIGS. 6 and 7.

FIG. 6 is a simulation graph showing changes in antenna characteristics due to the fabrication error in the conventional stacked patch antenna.

The detailed dimension of the stacked patch antenna used for the simulation is as follows: the area of the upper patch is 0.5 mm×0.8 mm, the area of the lower patch is 0.4 mm×0.8 mm, the thickness of the substrate between the upper and lower patches is 0.2 mm, the thickness of the substrate between the lower patch and the ground is 0.2 mm, and the thickness of the substrate of the feeder is 0.1 mm, and the dielectric constant of the substrate is 6.

In the drawing, the return loss of the conventional stacked patch antenna depending on the frequency is represented by a continuous line, the antenna which has no change in dimension thereof is represented by 0%. In addition, when the antenna is changed in the dimension to have changed portions of ±5%, respectively, the return loss results depending on the frequency are also shown.

FIG. 7 is a simulation graph showing changes in antenna characteristics due to the fabrication error in the dielectric resonator antenna embedded in the multilayer substrate according to the first embodiment of the present invention.

As such, the detailed dimension of the dielectric resonator antenna used for the simulation is as follows: the length a in the direction of x parallel to the length of the feed line 5a is 0.3 mm, the length b in the direction of y is 0.9 mm, and the length (thickness) c in the direction of z is 0.5 mm, and the dielectric constant of the substrate is 6.

In the drawing, the return loss of the dielectric resonator antenna embedded in the multilayer substrate according to the first embodiment depending on the frequency is represented by a continuous line, the antenna which has no change in dimension thereof is represented by 0%. In addition, when the antenna is changed in the dimension to have changed portions of ±5%, respectively, the return loss results depending on the frequency are also shown.

With reference to FIGS. 6 and 7, −10 dB matching frequency shift (intervals among a-b-c points in FIG. 6) due to the fabrication error in the conventional stacked patch antenna is greater than the frequency shift (intervals among a-b-c points in FIG. 7) due to the fabrication error in the dielectric resonator antenna embedded in the multilayer substrate according to the first embodiment.

As mentioned above, this indicates that the dielectric resonator antenna embedded in the multilayer substrate 1 according to the first embodiment has lower sensitivity to fabrication error than the conventional stacked patch antenna.

Specifically, in the conventional patch antenna or stacked patch antenna, the resonant frequency is determined by the length in the direction of x parallel to the length of the feed line of the patch antenna.

Conversely, in the dielectric resonator antenna embedded in the multilayer substrate 1 according to the first embodiment, the resonant frequency is determined by the length a in the direction of x, the length b in the direction of y and the length (thickness) c in the direction of z, thus reducing the effects of fabrication error in any one direction on the resonant frequency.

FIG. 8 is a graph showing the frequency shift depending on the fabrication error in the conventional stacked patch antenna and the dielectric radiator antenna according to the present invention.

As shown in FIG. 8, although the frequency shift of the conventional stacked patch antenna depending on the fabrication error changes proportionally, the dielectric resonator antenna embedded in the multilayer substrate according to the first embodiment has almost the constant frequency shift depending on the fabrication error.

Specifically, in the dielectric resonator according to the present invention, the fabrication error does not greatly affect the frequency shift, thus exhibiting lower sensitivity to fabrication error than the conventional stacked patch antenna.

The dielectric resonator antenna embedded in the multilayer substrate according to the present invention may manifest the same effects and functions even when the dielectric resonator is not provided in the shape of a rectangular parallelepiped but rather in that of a cylinder.

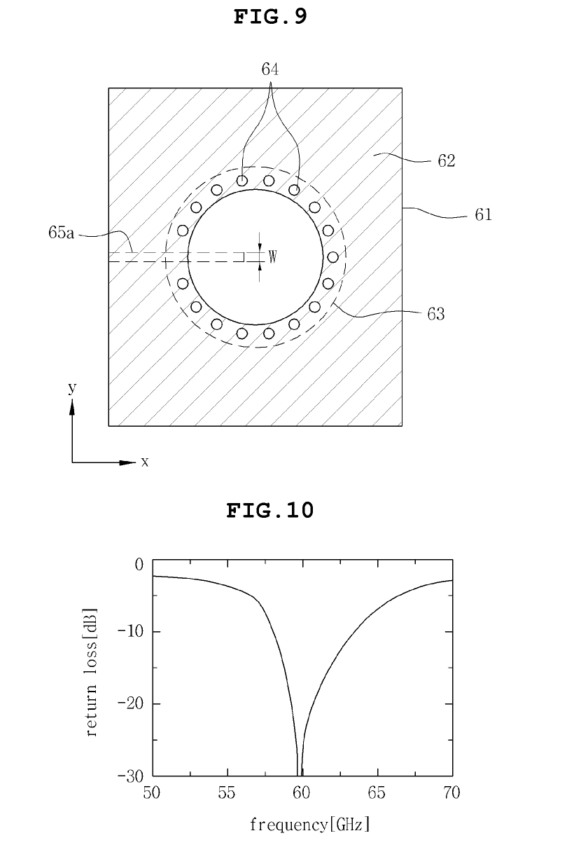

FIG. 9 is a top plan view showing a dielectric resonator antenna embedded in a multilayer substrate 61 according to a second embodiment of the present invention, in which the dielectric resonator has a cylinder shape.

In this case, the dielectric resonator includes a multilayer substrate 61, a first conductor plate 62, a second conductor plate 63, a plurality of metal via holes 64 for electrically connecting layers of the multilayer substrate 61, and a feed line 65a, as in the dielectric resonator antenna of FIGS. 1 to 5.

This dielectric resonator antenna has the same constituents and exhibits the same functions as in the dielectric resonator antenna embedded in the multilayer substrate 1 according to the first embodiment as shown in FIGS. 1 to 5, with the exception of the shape of the opening of the first conductor plate 62, and the detailed description thereof is thus omitted.

The dielectric resonator antenna embedded in the multilayer substrate 61 according to the second embodiment may be fabricated by adjusting the diameter R and the thickness c of the cylinder in order to resonate at a desired frequency.

FIG. 10 is a simulation graph showing return loss depending on frequency in the dielectric resonator antenna embedded in the multilayer substrate 61 according to the second embodiment of the present invention.

The detailed dimension of the dielectric resonator used for the simulation includes the diameter R of 0.3 mm and the thickness c of 0.6 mm, and the dielectric constant of the substrate is 6.

In this case, even when the dielectric resonator has the cylinder shape, similar return loss characteristics depending on the frequency may result as shown in the graph of FIG. 7.

Thus, in the dielectric resonator antenna according to the present invention, it can be seen that changes in antenna characteristics due to the fabrication error are small, regardless of the shape of the dielectric resonator embedded in the multilayer substrate.

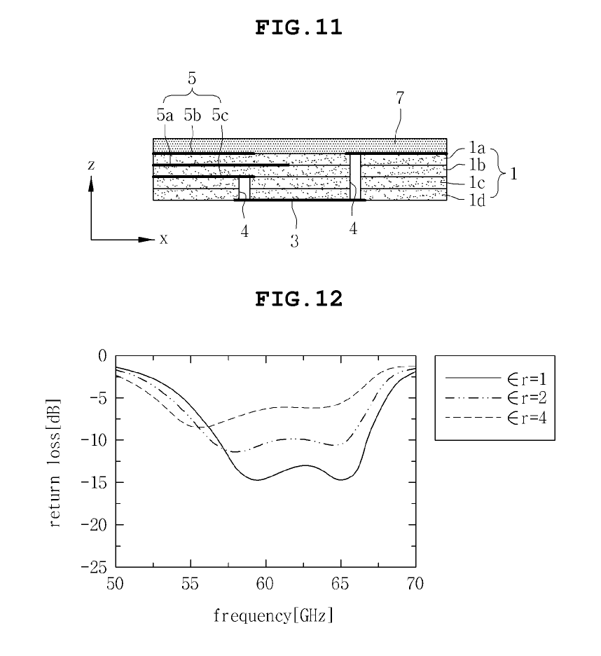

On the other hand, compared to the conventional patch antenna or stacked patch antenna, the dielectric resonator antenna embedded in the multilayer substrate according to the present invention is also advantageous because changes in antenna characteristics in response to the external environment are small, which is described with reference to FIGS. 11 to 13.

FIG. 11 is a cross-sectional view showing the dielectric resonator antenna of FIGS. 1 to 5 further including an outer dielectric. As shown in FIG. 11, the outer dielectric 7 is additionally formed on the radiation opening of the dielectric resonator antenna of FIGS. 1 to 5.

When the outer dielectric 7 is added in this way, an apparent difference in changes in antenna characteristics in response to the external environment between the conventional patch antenna and the antenna according to the present invention can be seen from the return loss results depending on the frequency.

FIG. 12 is a simulation graph showing the return loss depending on the frequency at different dielectric constants (∈ᵣ) of the outer dielectric 7 which is further added to the conventional stacked patch antenna.

As such, the conventional stacked patch antenna used for the simulation has the same dimension as that of the antenna of FIG. 6.

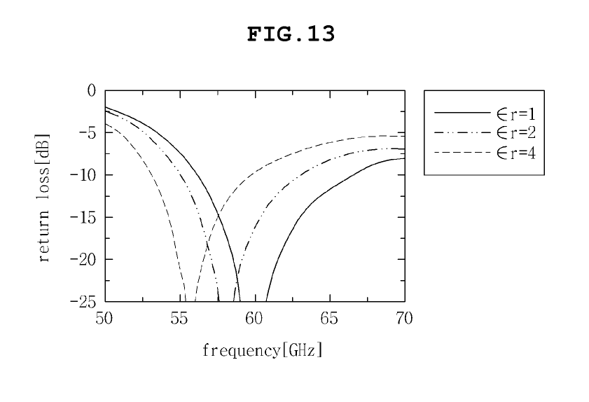

FIG. 13 is a simulation graph showing the return loss depending on the frequency at different dielectric constants (∈ᵣ) of the outer dielectric 7 which is further added to the dielectric resonator antenna of FIGS. 1 to 5.

As such, the dielectric resonator antenna according to the present invention used for simulation has the same dimension as that of the antenna of FIG. 7.

Comparing FIG. 12 with FIG. 13, in FIG. 12, not only the frequency shift but also the return loss can be seen to greatly change at different dielectric constants (∈ᵣ) of the outer dielectric 7.

Specifically, the return loss becomes greater as the dielectric constant (∈ᵣ) of the outer dielectric 7 is higher on the basis of a return loss of −10 dB.

In particular, in the case where the dielectric constant (∈ᵣ) of the outer dielectric 7 is 4 (represented by a dotted line), a return loss of −10 dB or more is caused at any frequency, undesirably causing poor antenna characteristics.

However, in FIG. 13, the resonant frequency may shift at different dielectric constants of the outer dielectric 7, but the similar return loss pattern is maintained on the basis of a return loss of −10 dB.

Specifically, in the dielectric resonator antenna embedded in the multilayer substrate according to the present invention, even when the dielectric constant (∈ᵣ) of the outer dielectric 7 is increased, only the resonant frequency shifts and the return loss remains good.

Thus, compared to the conventional stacked patch antenna, the dielectric resonator antenna embedded in the multilayer substrate according to the present invention is advantageous because changes in antenna characteristics in response to the external environment are small.

Meanwhile, the feeder for applying high frequency signals to the conventional dielectric resonator antenna fabricated outside the substrate is ideally embodied by a method of applying current using a metal probe that is inserted into the dielectric resonator.

However, for the sake of the fabrication, a feed method through coupling between the transmission line provided inside the substrate and the dielectric resonator provided outside the substrate is adopted.

The feeder 5 having a multilayer structure, such as a strip line, a microstrip line and a CPW line, may be easily embodied because the dielectric resonator which is an antenna radiator is embedded in the multilayer substrate 1.

Below, the structure of the feeder in various forms and the position relationship of the feed line based thereon are described with reference to FIGS. 14 to 22.

In FIGS. 14 to 22, the feeder 5 of the dielectric resonator antenna embedded in the multilayer substrate 1 according to the first embodiment is illustrated but may be applied not only to the dielectric resonator antenna according to the second embodiment but also to a dielectric resonator antenna having another shape (e.g. a polygonal pillar shape) embedded in the multilayer substrate 1.

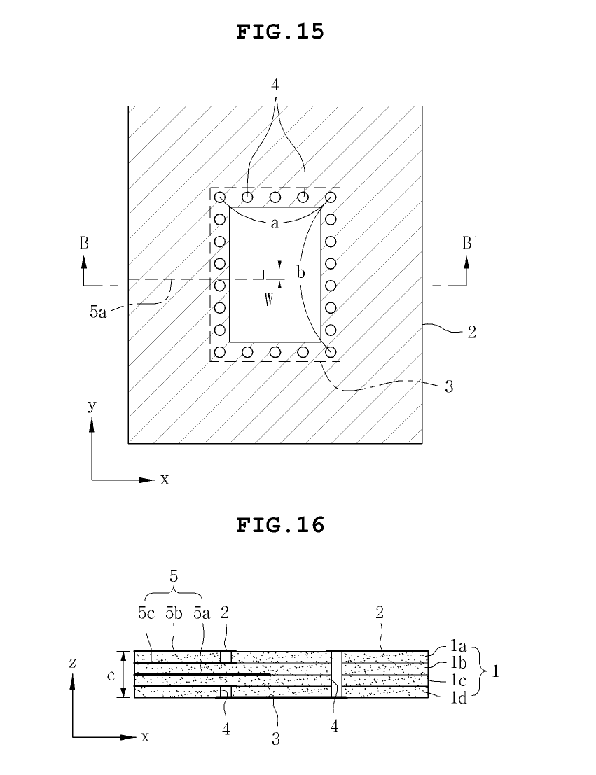

FIGS. 14 to 16 illustrate the dielectric resonator antenna embedded in the multilayer substrate 1 according to the first embodiment, which includes a feeder 5 having a strip line structure. Specifically, FIG. 14 is an exploded perspective view showing the dielectric resonator antenna which includes the feeder 5 having a strip line structure, FIG. 15 is a top plan view of FIG. 14, and FIG. 16 is a cross-sectional view of FIG. 14 taken along the line B-B′ of FIG. 15.

The feeder of the dielectric resonator antenna of FIGS. 14 to 16 is similar to the feeder 5 of FIG. 1, with the exception of the position of the feed line 5a of the feeder 5 of the dielectric resonator antenna of FIG. 1, and the detailed description of respective constituents is omitted.

When the structure of the feeder 5 of FIG. 14 is compared with the structure of the feeder 5 of FIG. 1, the position of the feed line 5a is different.

Whereas the feed line 5a of FIG. 1 is located between the first insulating layer 1a and the second insulating layer 1b, the feed line 5a of FIG. 14 is located between the second insulating layer 1b and the third insulating layer 1c.

Like this, the feeder 5 having the strip line structure includes the feed line 5a, and first and second ground plates 5b, 5c respectively formed on upper and lower insulating layers resulting from stacking one or more insulating layers upward and downward from the feed line 5a.

Thus, the positions of the first and second ground plates 5b, 5c may vary depending on the position of the feed line 5a, and the feed line 5a in the strip line structure may be located at any position between the bottom of the uppermost insulating layer 1a and the top of the lowermost insulating layer 1d.

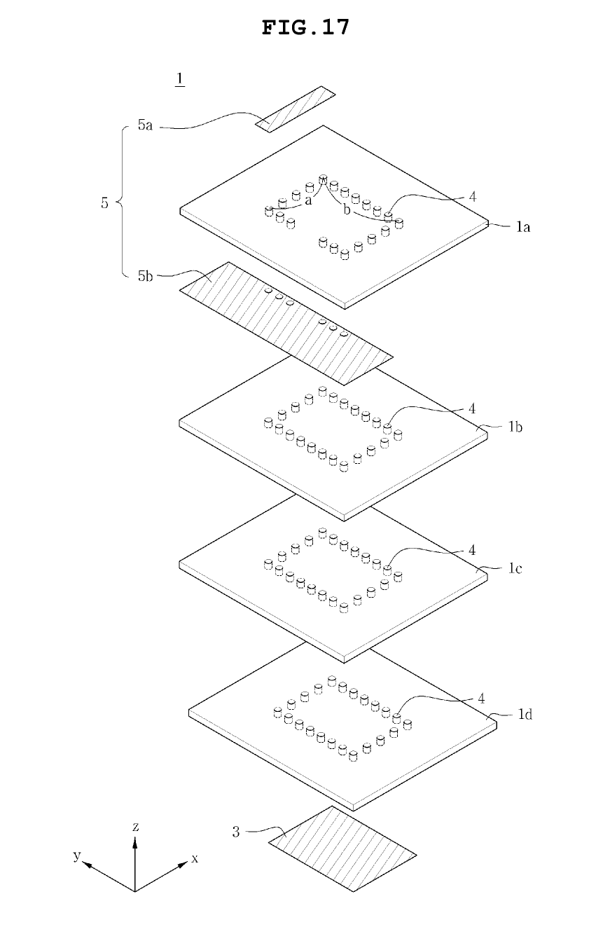

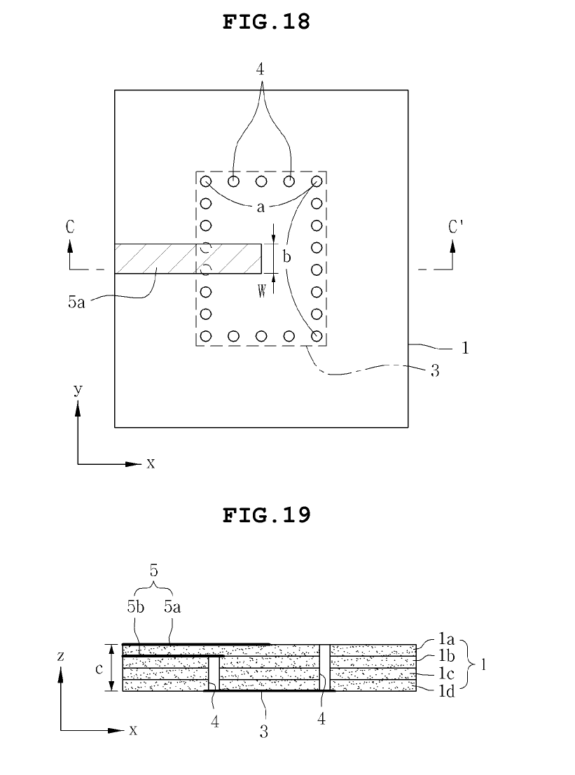

FIGS. 17 to 19 illustrate the dielectric resonator antenna embedded in the multilayer substrate 1 according to the first embodiment, which includes a feeder 5 having a microstrip line structure. Specifically, FIG. 17 is an exploded perspective view showing the dielectric resonator antenna which includes the feeder 5 having a microstrip line structure, FIG. 18 is a top plan view of FIG. 17, and FIG. 19 is a cross-sectional view of FIG. 17 taken along the line C-C′ of FIG. 18.

The feeder 5 having the microstrip line structure as shown in FIGS. 17 to 19 includes a feed line 5a composed of a conductor plate in line form extending from one side of the dielectric resonator to be inserted to the inside of the dielectric resonator so as to be parallel to the opening of the dielectric resonator.

Also the feeder 5 includes a ground plate 5b located to correspond to the feed line 5a and formed on the bottom of the insulating layer 1a resulting from stacking at least one insulating layer from the feed line 5a.

As such, the end of the feed line 5a of the feeder 5 having the microstrip line structure may have a traditional straight shape, or may be provided in the form of a step shape 5a-1, a taper shape 5a-2 or a round shape 5a-3, as shown in FIG. 3.

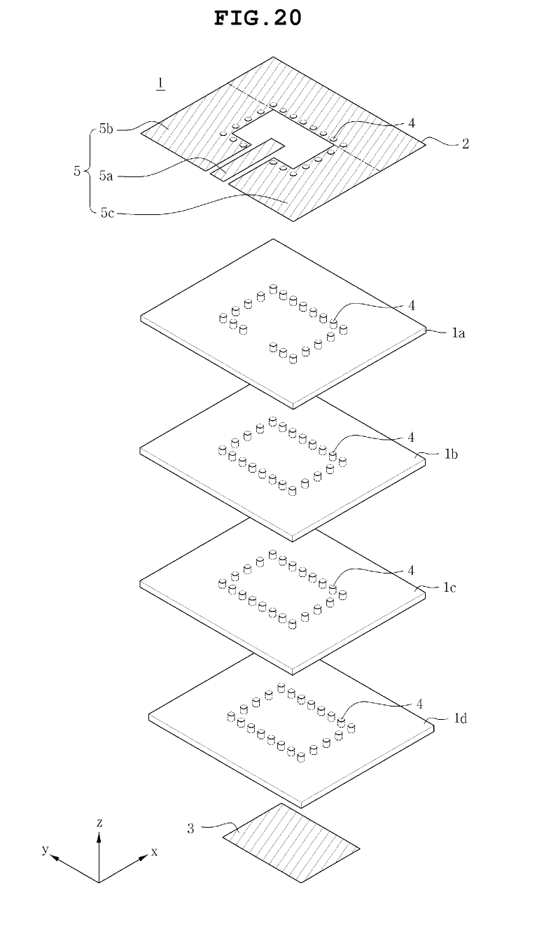

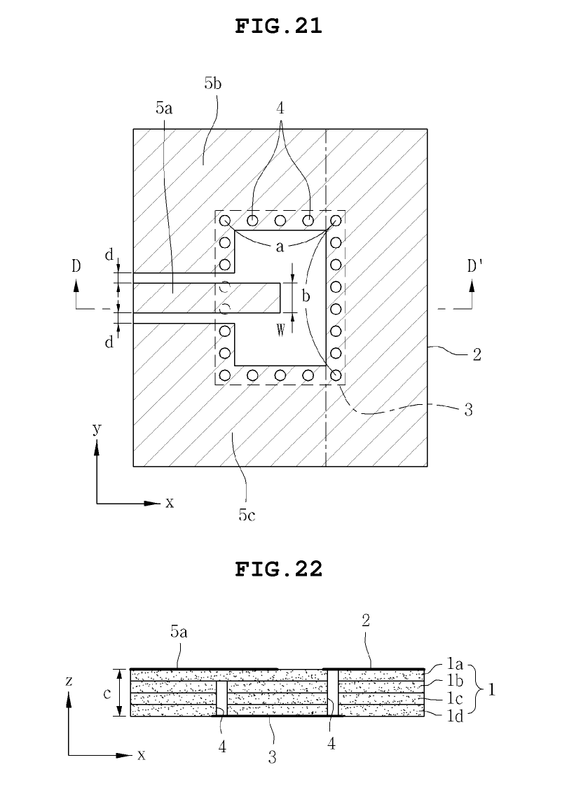

FIGS. 20 to 22 illustrate the dielectric resonator antenna embedded in the multilayer substrate 1 according to the first embodiment, which includes a feeder 5 having a CPW line structure. Specifically, FIG. 20 is an exploded perspective view showing the dielectric resonator antenna which includes the feeder 5 having a CPW line structure according to the present invention, FIG. 21 is a top plan view of FIG. 20, and FIG. 22 is a cross-sectional view of FIG. 20 taken along the line D-D′ of FIG. 21.

The feeder 5 having the CPW line structure as shown in FIGS. 20 to 22 includes a feed line 5a composed of a conductor plate in line form extending from one side of the dielectric resonator to be inserted to the inside of the dielectric resonator so as to be parallel to the opening of the dielectric resonator.

The feeder 5 also includes a first ground plate 5b which is formed on the same surface as the feed line 5a and is spaced apart from one side of the feed line 5a at a predetermined distance d and a second ground plate 5c which is formed on the same surface as the feed line 5a and is spaced apart from the other side of the feed line 5a at a predetermined distance d.

As such, the first and second ground plates 5b, 5c may be integrated with the first conductor plate 2

The feed line 5a in the microstrip line structure or the CPW line structure may be formed on the top of the uppermost insulating layer 1a of the multilayer substrate 1.

The end of the feed line 5a of the feeder 5 having the CPW line structure may have a traditional straight shape, or may be provided in the form of a step shape 5a-1, a taper shape 5a-2 or a round shape 5a-3 as shown in FIG. 3.

Thereby, the feed line 5a of the dielectric resonator antenna embedded in the multilayer substrate according to the present invention may be located at any position except for the bottom of the lowermost insulating layer 1d of the multilayer substrate 1. Accordingly, the dielectric resonator antenna according to the present invention may be easily fabricated and variously utilized because of the high degree of freedom of design of the feed line 5a.

As described hereinbefore, the present invention provides a dielectric resonator antenna embedded in a multilayer substrate. In the dielectric resonator antenna embedded in the multilayer substrate according to the present invention, a bandwidth of about 10% or more can be ensured even using single resonance instead of multi-resonance.

Also compared to a conventional patch antenna or stacked patch antenna, the dielectric resonator antenna embedded in the multilayer substrate according to the present invention is advantageous because changes in antenna characteristics due to a fabrication error or in response to the external environment are small, and thus can be easily fabricated and utilized variously.

Also the dielectric resonator antenna embedded in the multilayer substrate according to the present invention is configured such that radiation patterns thereof are collected toward an opening, thus exhibiting superior antenna gain characteristics and facilitating the dissipation of heat to the outside via the opening resulting in high heat dissipation efficiency.

Although the embodiments of the present invention have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A dielectric resonator antenna embedded in a multilayer substrate, comprising:
a multilayer substrate formed by alternately stacking a plurality of insulating layers and a plurality of conductor layers;
a first conductor plate having an opening and formed on a top of an uppermost insulating layer of the multilayer substrate;
a second conductor plate formed on a bottom of a lowermost insulating layer resulting from stacking at least two insulating layers downward from the first conductor plate and located at a position corresponding to the opening;
a plurality of metal via holes formed to perpendicularly pass through the multilayer substrate so as to form interlayer electrical connections between the uppermost insulating layer and the lowermost insulating layer and so as to be arranged around the opening of the first conductor plate at a predetermined interval thus forming a metal boundary in a perpendicular direction; and
a feeder for applying a high-frequency signal to a dielectric resonator embedded in cavity form in the multilayer substrate by metal boundaries defined by the first conductor plate, the second conductor plate and the plurality of metal via holes.

2. The dielectric resonator antenna as set forth in claim 1, wherein the dielectric resonator has a hexahedron shape.

3. The dielectric resonator antenna as set forth in claim 1, wherein the dielectric resonator has a cylinder shape.

4. The dielectric resonator antenna as set forth in claim 1, wherein the dielectric resonator has a polygonal pillar shape.

5. The dielectric resonator antenna as set forth in claim 1, wherein the feeder has a strip line structure.

6. The dielectric resonator antenna as set forth in claim 5, wherein the strip line structure comprises:
a feed line comprising a conductor plate in line form extending from one side of the dielectric resonator to be inserted to an inside of the dielectric resonator so as to be parallel to the opening of the dielectric resonator;
a first ground plate located to correspond to the feed line and formed on a top of an insulating layer resulting from stacking at least one insulating layer upward from the feed line; and
a second ground plate located to correspond to the feed line and formed on a bottom of an insulating layer resulting from stacking at least one insulating layer downward from the feed line.

7. The dielectric resonator antenna as set forth in claim 6, wherein the first ground plate is integrated with the first conductor plate.

8. The dielectric resonator antenna as set forth in claim 6, wherein the feed line is formed between a bottom of the uppermost insulating layer and a top of the lowermost insulating layer.

9. The dielectric resonator antenna as set forth in claim 6, wherein the feed line has an end having a straight shape, a step shape, a taper shape or a round shape.

10. The dielectric resonator antenna as set forth in claim 1, wherein the feeder has a microstrip line structure.

11. The dielectric resonator antenna as set forth in claim 10, wherein the microstrip line structure comprises:
a feed line comprising a conductor plate in line form extending from one side of the dielectric resonator to be inserted to an inside of the dielectric resonator so as to be parallel to the opening of the dielectric resonator; and
a ground plate located to correspond to the feed line and formed on a bottom of an insulating layer resulting from stacking at least one insulating layer from the feed line.

12. The dielectric resonator antenna as set forth in claim 11, wherein the feed line is formed on the top of the uppermost insulating layer.

13. The dielectric resonator antenna as set forth in claim 11, wherein the feed line has an end having a straight shape, a step shape, a taper shape or a round shape.

14. The dielectric resonator antenna as set forth in claim 1, wherein the feeder has a coplanar waveguide line structure.

15. The dielectric resonator antenna as set forth in claim 14, wherein the coplanar waveguide line structure comprises:
a feed line comprising a conductor plate in line form extending from one side of the dielectric resonator to be inserted to an inside of the dielectric resonator so as to be parallel to the opening of the dielectric resonator;
a first ground plate formed on a surface same as the feed line and spaced apart from one side of the feed line; and
a second ground plate formed on the surface same as the feed line and spaced apart from the other side of the feed line.

16. The dielectric resonator antenna as set forth in claim 15, wherein the first ground plate and the second ground plate are integrated with the first conductor plate.

17. The dielectric resonator antenna as set forth in claim 15, wherein the feed line is formed on the top of the uppermost insulating layer.

18. The dielectric resonator antenna as set forth in claim 15, wherein the feed line has an end having a straight shape, a step shape, a taper shape or a round shape.
